(19) United States
(12) Patent Application Publication
(10) Pub. No.: US 2026/0052294 A1
(43) Pub. Date: Feb. 19, 2026

(54) STATELESS TELEVISION RECOMMENDATIONS

(71) Applicant: Google LLC, Mountain View, CA (US)

(72) Inventors: Tamojit Chatterjee, Shyamnagar (IN); Shravan Nayak, Bangalore (IN)

(21) Appl. No.: 18/805,148

(22) Filed: Aug. 14, 2024

(51) Int. Cl. H04N 21/482

(52) U.S. Cl. CPC H04N 21/4826

(57) ABSTRACT

A method may include displaying, by a computing device, media content recommendations in a user interface of a television application based on at least one known preference of a user. A method may receive, by the computing device, a request for media content suggestions not based on the at least one known preference of the user. A method may in response to receiving the request for the media content suggestions, initiate, by the television application, a stateless recommendation process. A method may generate, by the stateless recommendation process, the media content suggestions. A method may display the media content suggestions in the user interface of the television application, and may receive a selection of at least one media content item associated with a respective media content suggestion. A method may update, by the stateless recommendation process, the media content suggestions based on the at least one media content item.

### BACKGROUND

A television (TV) application may present various types of media content of interest to a user. The media content may have different formats such as streaming video and audio. The types of media content may include, but are not limited to, movies, television shows, sporting events, news items, short form videos, and music. In addition, or in the alternative, a variety of media content providers may deliver various types of media content for viewing by the user. The TV application may deliver a customized viewing experience to a user that spans the diverse types of media content provided by the variety of media content providers.

### SUMMARY

In some non-limiting examples, a television application may present a user with recommendations for media content that may be of interest to the user based on a current mood or situation of the user. For example, a user interested in action movies may want the television application to suggest romantic comedy movies for viewing during a date night. The user may want the romantic comedy suggestions from the television application just for the date night. The user may not want the television application to use the selection of a romantic comedy movie as a basis for future media content recommendations for the user.

A television application may interact with a stateless recommendation process on a network-connected display device of a user (e.g., a smart TV) that starts with a blank slate and fine tunes media content suggestions based on iterative media content item selection by the user until the user decides to either watch a particular media content item or end the stateless recommendation process. The stateless recommendation process may not store or otherwise retain any of the user input to the stateless recommendation process so that the media content item selections of the user may not influence future media content recommendations.

In some aspects, the techniques described herein relate to a method including: displaying, by a computing device, media content recommendations in a user interface of a television application based on at least one known preference of a user; receiving, by the computing device, a request for media content suggestions not based on the at least one known preference of the user; in response to receiving the request for the media content suggestions, initiating, by the television application, a stateless recommendation process; generating, by the stateless recommendation process, the media content suggestions; displaying the media content suggestions in the user interface of the television application; receiving a selection of at least one media content item associated with a respective media content suggestion; and updating, by the stateless recommendation process, the media content suggestions based on the at least one media content item.

In some aspects, the techniques described herein relate to a method, wherein the media content recommendations are displayed on a home screen of the television application.

In some aspects, the techniques described herein relate to a method, wherein updating the media content suggestions based on the at least one media content item includes generating, by the stateless recommendation process, media content suggestions that include media content items semantically similar to the at least one media content item.

In some aspects, the techniques described herein relate to a method, wherein the media content suggestions include media content items associated with different genres.

In some aspects, the techniques described herein relate to a method, wherein the method further includes identifying at least one genre associated with the at least one media content item; and wherein updating the media content suggestions based on the at least one media content item includes generating, by the stateless recommendation process, media content suggestions that include media content items associated with the at least one genre.

In some aspects, the techniques described herein relate to a method, further including: subsequent to displaying the media content suggestions in the user interface of the television application, receiving an indication to end the stateless recommendation process; and terminating, by the television application, the stateless recommendation process, the terminating including not storing any selections received by the stateless recommendation process.

In some aspects, the techniques described herein relate to a method, wherein the method further includes: subsequent to terminating the stateless recommendation process, redisplaying the media content recommendations in the user interface of the television application; receiving an indication of a selection of a media content item associated with a respective media content recommendation of the media content recommendations; and playing, by the television application, the media content item on the computing device.

In some aspects, the techniques described herein relate to a method, wherein receiving the request for media content suggestions not based on the at least one known preference of the user is based on a mood of the user.

In some aspects, the techniques described herein relate to a non-transitory computer-readable medium storing executable instructions that when executed by at least one processor of a computing device cause the at least one processor to execute operations, the operations including: displaying, by the computing device, media content recommendations in a user interface of a television application based on at least one known preference of a user; receiving, by the computing device, a request for media content suggestions not based on the at least one known preference of the user; in response to receiving the request for the media content suggestions, initiating, by the television application, a stateless recommendation process; generating, by the stateless recommendation process, the media content suggestions; displaying the media content suggestions in the user interface of the television application; receiving a selection of at least one media content item associated with a respective media content suggestion; and updating, by the stateless recommendation process, the media content suggestions based on the at least one media content item.

In some aspects, the techniques described herein relate to a non-transitory computer-readable medium, wherein the media content recommendations are displayed on a home screen of the television application.

In some aspects, the techniques described herein relate to a non-transitory computer-readable medium, wherein updating the media content suggestions based on the at least one media content item includes generating, by the stateless recommendation process, media content suggestions that include media content items semantically similar to the at least one media content item.

In some aspects, the techniques described herein relate to a non-transitory computer-readable medium, wherein the media content suggestions include media content items associated with different genres.

In some aspects, the techniques described herein relate to a non-transitory computer-readable medium, wherein the operations further include identifying at least one genre associated with the at least one media content item; and wherein updating the media content suggestions based on the at least one media content item includes generating, by the stateless recommendation process, media content suggestions that include media content items associated with the at least one genre.

In some aspects, the techniques described herein relate to a non-transitory computer-readable medium, wherein the operations further include: subsequent to displaying the media content suggestions in the user interface of the television application, receiving an indication to end the stateless recommendation process; and terminating, by the television application, the stateless recommendation process, the terminating including not storing any selections received by the stateless recommendation process.

In some aspects, the techniques described herein relate to a non-transitory computer-readable medium, wherein the operations further include: subsequent to terminating the stateless recommendation process, redisplaying the media content recommendations in the user interface of the television application; receiving an indication of a selection of a media content item associated with a respective media content recommendation of the media content recommendations; and playing, by the television application, the media content item on the computing device.

In some aspects, the techniques described herein relate to a non-transitory computer-readable medium, wherein receiving the request for media content suggestions not based on the at least one known preference of the user is based on a mood of the user.

In some aspects, the techniques described herein relate to a system including: at least one processor; and a non-transitory computer-readable medium storing instructions that when executed by the at least one processor cause the system to: display media content recommendations in a user interface of a television application based on at least one known preference of a user; receive a request for media content suggestions not based on the at least one known preference of the user; in response to receiving the request for the media content suggestions, initiate, by the television application, a stateless recommendation process; generate, by the stateless recommendation process, the media content suggestions; display the media content suggestions in the user interface of the television application; receive a selection of at least one media content item associated with a respective media content suggestion; and update, by the stateless recommendation process, the media content suggestions based on the at least one media content item.

In some aspects, the techniques described herein relate to a system, wherein the media content recommendations are displayed on a home screen of the television application.

In some aspects, the techniques described herein relate to a system, wherein updating the media content suggestions based on the at least one media content item includes generating, by the stateless recommendation process, media content suggestions that include media content items semantically similar to the at least one media content item.

In some aspects, the techniques described herein relate to a system, wherein the instructions that when executed by the at least one processor further cause the system to identify at least one genre associated with the at least one media content item; and wherein updating the media content suggestions based on the at least one media content item includes generating, by the stateless recommendation process, media content suggestions that include media content items associated with the at least one genre.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example of a user interacting with a network-connected display device and a media adapter, according to implementations described throughout this disclosure.

FIG. 1B illustrates an example system for providing recommendations for new media content for a user based on a current mood or situation of the user, according to implementations described throughout this disclosure.

FIG. 2 is an illustration of an example user interface that a TV application may generate to begin a stateless recommendation process.

FIG. 3 is an illustration of an example user interface that a TV application may generate as part of a continuing stateless recommendation process.

FIG. 4 illustrates a flowchart depicting example operations of a stateless recommendation process according to implementations described throughout this disclosure.

### DETAILED DESCRIPTION

A television application may present a user with recommendations for media content that may be of interest to the user. The TV application may utilize a stateful recommendation process that determines what the user may be interested in watching based on, for example, media content (e.g., movies, TV shows, short form videos, music, etc.) the user listened to, viewed, and/or watched in the past. In addition, or in the alternative, the TV application may utilize the stateful recommendation process to determine what the user may be interested in watching based on, for example, interest of the user in particular genres (e.g., comedy, romance, action, crime, reality, etc.), In some implementations, however, the user may want the TV application to recommend media content in an area of interest that the user has previously not expressed interest in. For example, a user interested in action movies may want the TV application to recommend romantic comedy movies during a date night. However, the user may want the romantic comedy recommendations for watching just for the date night. The user may not want the TV application to include the selection of a romantic comedy movie as a basis for future media content recommendations for the user.

Television applications utilizing a stateful recommendation process may present a user with recommendations for media content that may be of interest to the user based on what the user has watched in the past and further fine tune the recommendations based on known user preferences. At least one technical problem is how to present recommendations for media content that may be of interest to the user that is not based on past viewing habits or choices and pre-determined tastes or likes associated with the user, but that is based on a current mood or situation of the user that may divert from the prior watch history and preferences of the user. For example, the user may want to explore different media content and genres. However, this may be a onetime occurrence, and the user may not want the current media content selections and choices to influence future media content recommendations.

A technical solution is to implement a stateless recommendation process that starts with a blank slate and fine tunes media content suggestions based on iterative media content item selection by the user until the user decides to either watch a particular media content item or end the stateless recommendation process. The stateless recommendation process may not store or otherwise retain any of the user input to the stateless recommendation process so that the media content item selections of the user may not influence future media content recommendations. The technical effect is to provide a user with the ability to explore different media content based on the mood or situation of the user without the media content item selections along with the activities and interactions of the user with a user interface presented by the television application for the stateless recommendation system from being stored and possibly influencing future media content recommendations by the television application.

The disclosure generally relates to systems and methods for implementing a stateless recommendation process on a computing device of a user (e.g., a smart TV).

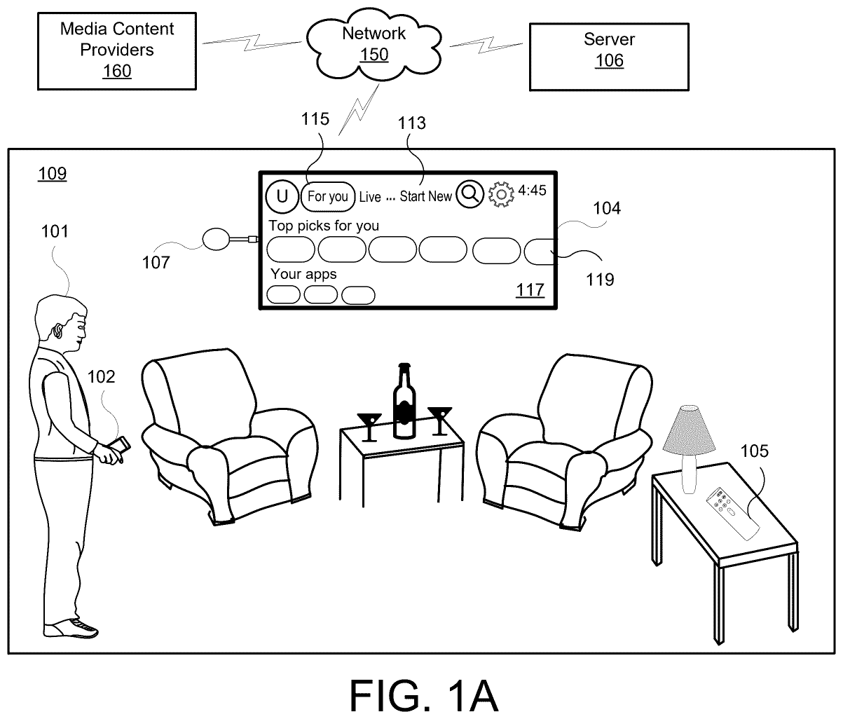

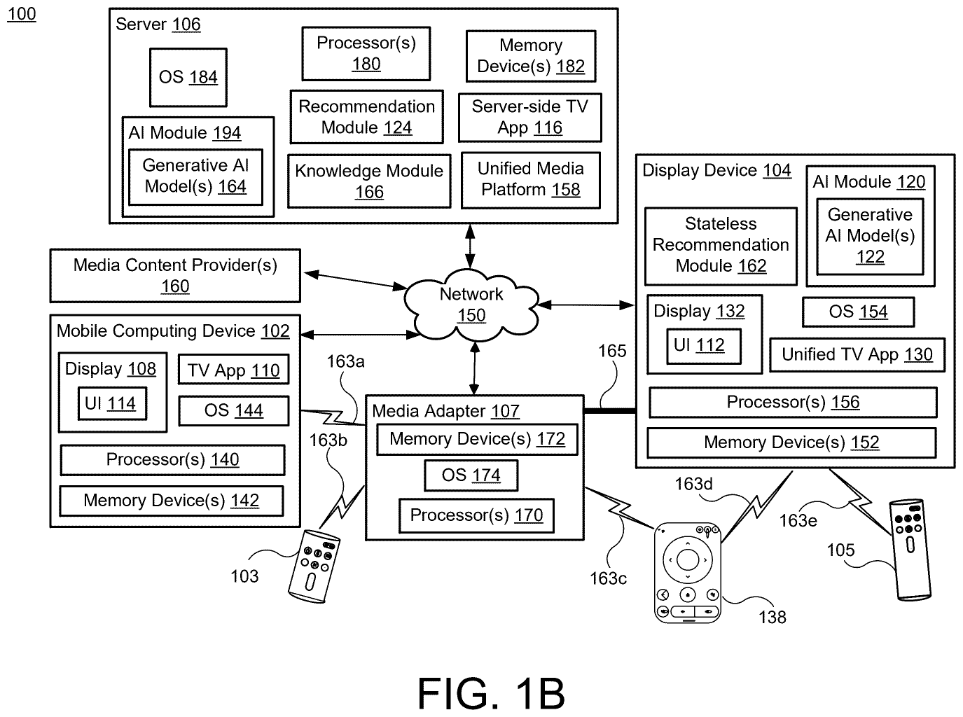

FIG. 1A illustrates an example of a user 101 interacting with a network-connected display device 104 and a media adapter 107 in an environment 109 of the user 101 (e.g., a room in the home of the user 101) according to implementations described throughout this disclosure. FIG. 1B illustrates an example system 100 for providing recommendations for new media content for a user based on a current mood or situation of the user, according to implementations described throughout this disclosure.

The new media content recommendations may not be based on previous user watch interests or behavior but based on the user exploring stateless media content recommendations that start with a blank slate. The recommendations may be tweaked or finetuned based on continuing user selections of the refined recommended media content. In some implementations, the user may select to stop or not continue to explore the stateless media content recommendations. In these implementations, the selections of the user may not be saved, stored, or otherwise used or considered for future media content recommendations. In some implementations, the user may select a media content item for watching, stopping the stateless media content recommendation process. In these implementations, the selections of the user may not be saved, stored, or otherwise used or considered for future media content recommendations.

Referring to FIGS. 1A-B, the network-connected display device 104 may communicate with a server computer 106 and media content providers 160 by way of a network 150. The media content providers 160, the network-connected display device 104, the server computer 106, and a mobile computing device 102 may interact with and communicate with one other by way of the network 150. In some implementations, the mobile computing device 102 may interface or connect to the media adapter 107 and/or the network-connected display device 104 by way of a wireless communication link that may be a short-range wireless connection such as, for example a Bluetooth connection or a Wi-Fi (e.g., direct Wi-Fi) connection.

In some implementations, a user (e.g., the user 101) may use and/or otherwise interact with a network-connected display device (e.g., network-connected display device 104). For example, a user may log into or otherwise access the account of the user by way of the network-connected display device allowing the user to experience a customized user experience when interacting with a television (TV) application (e.g., unified television (TV) application 130) on the network-connected display device (e.g., the network-connected display device 104). Though the interactions of the user 101 are described herein with reference to the system 100, in some implementations a user (e.g., the user 101) may use and/or otherwise interact with different network-connected display devices, mobile computing devices, media adapters, networks, and servers that perform like the system 100. In these implementations, the user may experience a customized user experience when interacting with a television (TV) application on the network-connected display device.

As described herein, the user 101 may click on or select a start new option 113 to start or initiate a stateless recommendation process, starting with a blank slate. The selection of the start new option 113 may be a request to the unified TV application 130 for media content suggestions not based on any watch history or preferences of the user 101. For example, the stateless recommendation process may not consider any past information and data related to the viewing or watch habits of the user along with any preferences of the user. The stateless recommendation process may be a localized session on the network-connected display device 104. In these implementations, even if the user 101 is logged into or is otherwise able to access the account of the user 101 by way of the network-connected display device 104, the past user watch behavior and other preferences of the user may not influence or be used in determining media content recommendations presented to the user 101 in a user interface (e.g., user interface (UI) 112)) on the network-connected display device 104 allowing the user 101 to explore new media content and to obtain media content recommendations based on a current mood or situation of the user 101. In some implementations as described herein, any information and data gathered by the stateless recommendation process may be discarded (not saved) once the user ends the stateless recommendation process.

For example, a user may choose between receiving media recommendations by way of a customized user experience or by a stateless recommendation process. The user 101 may select or click on a for you option 115 when interacting with the unified television (TV) application 130 on the network-connected display device 104. In response to the selection of the for you option 115, the unified TV application 130 may display a user interface 117 that provides the user 101 with media recommendations in a top picks for you row 119 in the user interface 117. In some implementations, the unified TV application 130 may display the user interface 117 in the UI 112 of a display 132 of the network-connected display device 104 in response to the launching of the unified TV application 130 on the network-connected display device 104. In these implementations, the user interface 117 may be referred to as the launch screen or home screen for the unified TV application 130. The unified TV application 130 may provide the media recommendations in the user interface 117 as a customized user experience based on a watch history of the user and other preferences of the user.

In some implementations, referring to FIG. 1A, the user 101 may connect to and interact with a media adapter (e.g., the media adapter 107) by way of a network-connected display device (e.g., the network-connected display device 104) using a server-side television (TV) application (e.g., server-side TV application 116) installed on a server computer (e.g., the server computer 106). The media adapter 107 may be connected or interfaced to the network-connected display device 104. The network-connected display device 104 may be communicatively coupled or connected to the server computer 106 by way of the network 150. In these implementations, a unified media platform (UMP) 158 may provide or serve media content items from the media content providers 160 to the network-connected display device 104 by way of the media adapter 107.

In some implementations, referring to FIG. 1A, the user 101 may interact with a network-connected display device (e.g., the network-connected display device 104) using a remote control device (e.g., a remote control device 105). In some implementations, a television (TV) application 110 may render a virtual remote control 138 in a user interface (e.g., UI 114) on a display (e.g., a mobile computing device display 108) on the mobile computing device 102. The virtual remote control 138 may allow the mobile computing device 102 to act as a remote control for the network-connected display device 104. The TV application 110 may render the virtual remote control 138 for use with the network-connected display device 104. The user may interact with the remote control device 105 and/or the virtual remote control 138 when selecting media content for viewing on the network-connected display device 104.

In some implementations, referring to FIG. 1A, the user 101 may connect to and interact with a media adapter (e.g., the media adapter 107) using a TV application (e.g., the television (TV) application 110) installed on a mobile computing device (e.g., the mobile computing device 102). In some implementations, the user 101 may connect to and interact with a media adapter (e.g., the media adapter 107) using a media adapter remote control device (e.g., media adapter remote control device 103). In some implementations, the TV application 110 may render the virtual remote control 138 for use with the media adapter 107. The virtual remote control 138 may allow the mobile computing device 102 to act as a remote control for the media adapter 107. The user 101 may interact with the virtual remote control 138 and/or the media adapter remote control device 103 when interacting with the media adapter 107.

The network-connected display device 104 may execute the unified television application 130. The unified television application 130 may interface with a server-side television (TV) application 116. The unified TV application 130 may interface with the server-side TV application 116 to obtain media content recommendations for displaying in the user interface as the top picks for you row 119 in the user interface 117.

The server computer 106 may include a knowledge module 166. The knowledge module 166 may include information associated with media content items provided by the media content providers 160. In some implementations, the knowledge module 166 may generate media content recommendations for associating with an account of a user based, in part, on a multi-dimensional user activity characteristic associated with the account of the user and the information associated with media content items provided by the media content providers 160. The user activity characteristic associated with the account of the user may be obtained from a plurality of information sources that may include, but are not limited to, a search engine, a mapping application, and an online retailer. The information sources may provide activity data related to activities of the account of the user by way of a respective software program or application.

In some implementations, the unified television application 130 may interface with the knowledge module 166 to provide information and data related to the past activities of the user when interacting with the unified television application 130, the viewing history of the user, and/or the popularity of media content items of a type, classification, category, group or genre.

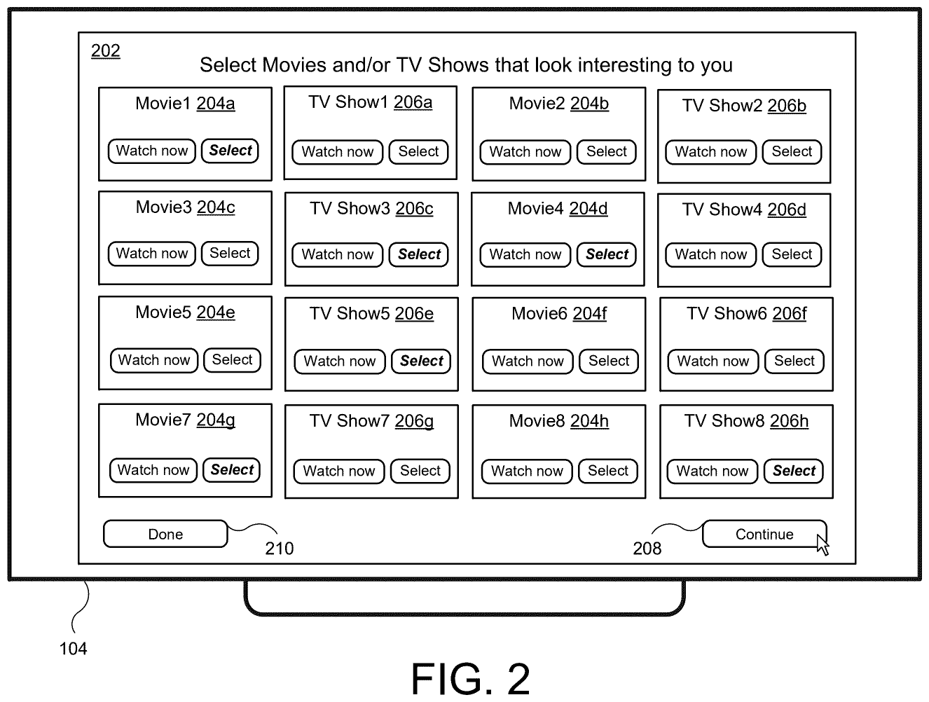

FIG. 2 is an illustration of an example user interface 202 that a TV application (e.g., the unified TV application 130) may generate to begin a stateless recommendation process. For example, the user 101 may select or click on the start new option 113. In response, the unified TV application 130 may interface with a stateless recommendation module 162 on the network-connected display device 104 to generate the user interface 202 and begin an interactive stateless recommendation process with the user 101.

Referring to FIGS. 1A-B, the user interface 202 may include suggested media content items for viewing by a user (e.g., the user 101). The unified television application 130 may interface with the stateless recommendation module 162 to determine, for example, movies and television (TV) shows to include in the user interface 202. For example, the stateless recommendation module 162 may suggest media content of different genres (e.g., action, comedy, romance, science fiction, drama, etc.). Based on a selection by the user of media content items of interest to the user, the stateless recommendation module 162 may determine or identify a particular genre of interest to the user. The stateless recommendation module 162 may then subsequently suggest additional media content items of that same genre as continued suggestions of media content of interest to the user.

Referring to FIG. 2, for example, the unified television application 130 may generate the user interface 202 that includes movies 204a-h and TV shows 206 a-h. A user (e.g., the user 101) may select none, one, or more than one (e.g., two or more) movies of interest (e.g., movie 204a, movie 204d, movie 204g) and/or none, one, or more than one (e.g., two or more) TV shows of interest (e.g., TV show 206c, TV show 206e, TV show 206h).

In some implementations, a user (e.g., the user 101) may decide to watch one of the suggested media content items. In these implementations, the user may select the corresponding watch now button for the media content item. In response to the selection, the unified television application 130 may obtain and play the media content item on the network-connected display device 104 as described herein ending the stateless recommendation process.

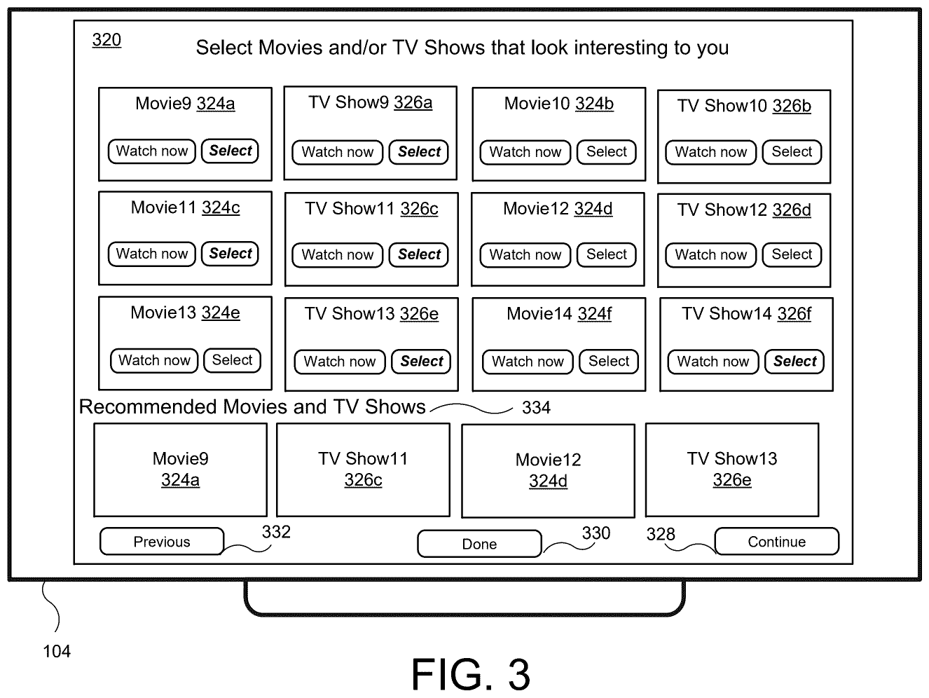

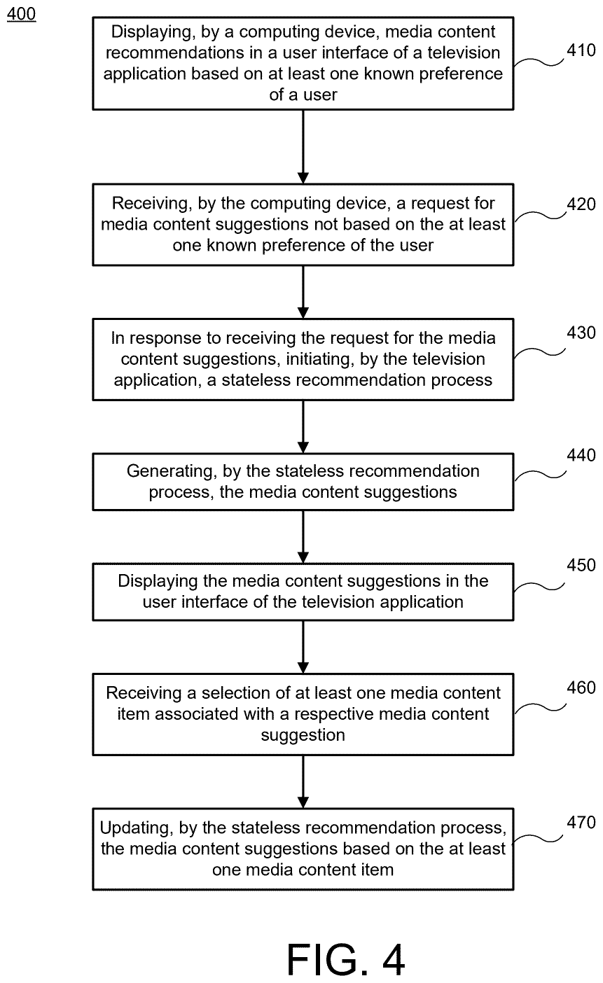

In some implementations, a user (e.g., the user 101) may decide to terminate, end, or not continue with the stateless recommendation process. In these implementations, the user may select or click on a done button 210. In response to the selection of the done button 210, the unified television application 130 may display (redisplay) the home screen (e.g., the user interface 117) and discard (not store) any information and data used to generate suggestions for media content items for viewing by the user. The ability of the user to end or terminate the stateless recommendation process allows the user to switch between the unified television application 130 providing media content recommendations by a stateful recommendation process (e.g., the top picks for you row 119) and a stateless recommendation process as described with reference to FIGS. 3 and 4.

FIG. 3 is an illustration of an example user interface 320 that a TV application (e.g., the unified television application 130) may generate as part of a continuing stateless recommendation process. For example, referring to FIG. 2, the user (e.g., the user 101) has selected movie 204a, movie 204d, movie 204g, TV show 206c, TV show 206e, and TV show 206h as media content items of interest. The user may select a continue button 208 to continue with the stateless recommendation process, updating a list of suggested movies of interest to the user. In response, the unified television application 130 may interface with the stateless recommendation module 162 and generate the user interface 320. The user interface 320 may include an updated list of additional suggested movies and TV shows (e.g., movies 322a-f, TV shows 324a-f).

The additional suggested movies and TV shows (e.g., movies 322a-f, TV shows 324a-f) may be selected as suggestions by the stateless recommendation module 162 based on the selection by the user of the movie 204a, movie 204d, movie 204g, TV show 206c, TV show 206e, and TV show 206h as media content items of interest. For example, based on the user selecting movie 204a, the stateless recommendation process may suggest movie 324a that may be a semantically similar movie. For example, based on the user selecting TV show 206c, the stateless recommendation process may suggest TV show 326a that may be a semantically similar TV show.

In some non-limiting examples, the suggestion of the additional movies and TV shows (e.g., movies 322a-f, TV shows 324a-f) may be based on the additional movies and TV shows (e.g., movies 322a-f, TV shows 324a-f) being of the same or similar genre to the selected movie 204a, movie 204d, movie 204g, TV show 206c, TV show 206e, and TV show 206h; the additional movies and TV shows (e.g., movies 322a-f, TV shows 324a-f) having common actors with the selected movie 204a, movie 204d, movie 204g, TV show 206c, TV show 206e, and TV show 206h; and/or the additional movies and TV shows (e.g., movies 322a-f, TV shows 324a-f) being set in a location that is the same or similar to location settings for the selected movie 204a, movie 204d, movie 204g, TV show 206c, TV show 206e, and TV show 206h.

Referring to FIG. 3, in some implementations a user (e.g., the user 101) may select none, one, or more than one (e.g., two or more) movies of interest (e.g., movie 324a, movie 324c) and/or none, one, or more than one (e.g., two or more) TV shows of interest (e.g., TV show 326a, TV show 326c, TV show 326e, TV show 326f).

In some implementations, a user (e.g., the user 101) may decide to watch one of the suggested media content items. In this implementation, the user may select the corresponding watch now button for the media content item. In response to the selection, the unified television application 130 may obtain and play the media content item on the network-connected display device 104 as described herein ending the stateless recommendation process.

In some implementations, a user (e.g., the user 101) may decide to terminate, end, or not continue with the stateless recommendation process. In these implementations, the user may select or click on a done button 330. In response to the selection of the done button 330, the unified television application 130 may display (redisplay) the home screen (e.g., the user interface 117) and discard (not store) any information and data used to generate suggestions for media content items for viewing by the user.

In some implementations, the user may want to go back to the previous screen to again view the previously suggested media content items. In these implementations, the user may select or click on a previous button 332. The unified television application 130 responsive to the selection of the previous button 332 may redisplay the user interface 202 that includes previously suggested media content items.

The user may select a continue button 208 to continue with the stateless recommendation process. In response, the unified television application 130 may interface with the stateless recommendation module 162 and generate the user interface 320. The user may select the continue button 208 to continue with the stateless recommendation process, updating a list of suggested movies of interest to the user. The user interface 320 may include an updated list of additional suggested movies and TV shows (e.g., movies 322a-f, TV shows 324a-f).

In some implementations, a user (e.g., the user 101) may decide to continue with the stateless recommendation process. In these implementations, the user may select or click on a continue button 328. In response to the selection of the continue button 328, the stateless recommendation module 162 may continue the stateless recommendation process to provide an updated list of additional suggested media content items (e.g., movies and TV shows) to the user. The stateless recommendation module 162 may determine the additional suggested media content items based on the further selection of the user of movies of interest (e.g., movie 324a, movie 324c) and TV shows of interest (e.g., TV show 326a, TV show 326c, TV show 326e, TV show 326f) further finetuning or tweaking the stateless recommendation process as further information and data related to the desires of the user is gathered by the stateless recommendation process.

Referring to FIGS. 1B, 2 and 3, the user interface 320 may include a recommended movies and TV shows row 334. The unified television application 130 may provide the selections of the user of movie 204a, movie 204d, and movie 204g and/or of TV show 206c, TV show 206e, and TV show 206h to the stateless recommendation module 162. The stateless recommendation module 162 may provide the selections to a generative artificial intelligence (AI) module 120. The stateless recommendation module 162 may pass the selected movies (e.g., movie 204a, movie 204d, and movie 204g) and/or the selected TV shows (e.g., TV show 206c, TV show 206e, and TV show 206h) to the generative AI module 120 in a prompt, asking the generative AI module 120 to generate additional movies and/or or TV shows (media content items) that may be of interest to the user based on these previous selections. In some implementations, the prompt provided to the generative AI module 120 by the generative AI module 120 may be tuned by including diversity and random sampling to ensure that the user is provided with suggestions that are diverse each time the user selects suggested media content items. For example, the generative AI module 120 may ask the generative AI module 120 to recommend a number of media content items (N+K) that is larger than a number of media content items (N) selected by the generative AI module 120 to provide to the unified television application 130 for displaying in a user interface for selection by the user.

In some implementations, the stateless recommendation module 162 may utilize an embedding based approach that follows, for example, a retrieval augmented generation process for media content items. For example, as a user interacts with the user interface for the unified television application 130 by continuing to select movies and/or TV shows (media content items) of interest to the user, the suggestions provided by the stateless recommendation module 162 at each iteration of the stateless recommendation process may be tweaked or finetuned based on the past media content items selected by the user.

For example, the stateless recommendation module 162 may use the generative AI module 120 to generate movie embeddings by using a function to generate a combined movie embedding for a list of movies presented for selection by a user in a user interface of the television application 130 as described with reference to FIGS. 2 and 3. Equation 1 is an example of an average embedding for movies. In some implementations, the average may be weighted based on, for example, a determined popularity or quality of the movie, or a number of clicks or selection of the movie by users.

$${Emb}_{MovieCombined} = F ( {Emb}_{movie 1} , {Emb}_{movie 2} , … {Emb}_{movieN} ) \qquad Equation 1$$

In another example, the stateless recommendation module 162 may use the generative AI module 120 to generate TV show embeddings by using a function to generate a combined TV show embedding for a list of TV shows presented for selection by a user in a user interface of the television application 130 as described with reference to FIGS. 2 and 3. Equation 2 is an example of an average embedding for TV shows. In some implementations, the average may be weighted based on, for example, a determined popularity or quality of the TV show, or a number of clicks or selection of the TV show by users.

$${Emb}_{TVshowCombined} = F ( {Emb}_{TVshow 1} , {Emb}_{TVshow 2} , … {Emb}_{TVshowN} ) \qquad Equation 2$$

In some implementations, a machine learning model included in generative artificial intelligence (AI) models 122 may combine one or more weights for the embeddings using nonlinear transformations. The unified television application 130 may retrieve movies and/or TV shows similar to the media content items as selected by a user from a catalog of media content items provided by the media content providers 160 based on the generated embeddings. The generated embeddings may be further provided to the generative AI module 120 in a prompt, asking the generative AI module 120 to generate additional movies and/or or TV shows (media content items) that may be of interest to the user based on these previous selections as the stateless recommendation process is further refined.

For example, referring to FIG. 2, the user 101 selected the movie 204a, the movie 204d, and the movie 204g as movies the user 101 may be interested in watching. The stateless recommendation module 162 may include the movie 204a (movie1), the movie 204d (movie4), and the movie 204g (movie7) in a list of selected movies. The stateless recommendation module 162 may convert the movie 204a into a respective embedding (e.g., Embₘₒᵥᵢₑ₁). The stateless recommendation module 162 may convert the movie 204d into a respective embedding (e.g., Embₘₒᵥᵢₑ₄). The stateless recommendation module 162 may convert the movie 204g into a respective embedding (e.g., Embₘₒᵥᵢₑ₇).

In some implementations, the stateless recommendation module 162 may use a mathematical function such as, for example, an average function to generate a final embedding for the selected movies. For example, the stateless recommendation module 162 may use a function as shown in Equation 3 to calculate a final embedding for the user 101.

$${Emb}_{movie \_ final 1} = Average ( {Emb}_{movie 1} , {Emb}_{movie 4} , {Emb}_{movie 7} ) \qquad Equation 3$$

For example, the stateless recommendation module 162 may use a function as shown in Equation 4 to calculate a final embedding for the user 101. The function shown in Equation 4 may weight each embedding for a movie by a popularity rating for the movie.

$${Emb}_{movie \_ final 2} = Average ( popularity of movie 1 * {Emb}_{movie 1} , popularity of movie 4 * {Emb}_{movie 4} , popularity of movie 7 * {Emb}_{movie 7} ) \qquad Equation 4$$

The stateless recommendation module 162 interfacing with the unified television application 130 may use a calculated final embedding for a user to search for movies similar to the movies previously selected by the user for making future suggestions to the user. For example, the unified television application 130 may identify a number of popular movies (e.g., 100,000, 10,000, 1000, etc.) for including in a list of popular movies. The stateless recommendation module 162 may convert each movie in the list of popular movies into a respective movie embedding by interfacing with the generative AI module 120. The stateless recommendation module 162 may temporarily include the movie embeddings in a database in the network-connected display device 104. The stateless recommendation module 162 may perform a dot product with the final embedding for the user and a movie embedding for each movie in the list of popular movies. For example, the result of the dot product may be a number or score between −1 and +1. A score of +1 between the final embedding for the user and a movie embedding may indicate that the movie is very similar to movies previously selected by the user. A score of −1 between the final embedding for the user and a movie embedding may indicate that the movie is not similar to (nearly opposite of) movies previously selected by the user.

After calculating a dot product for each movie included in the list of popular movies, the stateless recommendation module 162 may sort the results of the dot products based on the scores, where the movies with the highest scores are included at a top of a list of suggested movies because the higher scoring movies are more likely to be similar to movies previously selected by the user as movies of interest to the user. In some implementations, the stateless recommendation module 162 may generate a filtered list of suggested movies by removing one or more movies from the list of suggested movies based on criteria associated with the user. In one non-limiting example, the user may not be able to watch a suggested movie for free because the user may not have a subscription with the media content provider of the suggested movie. In another non-limiting example, the movie may be restricted from playing or watching by the user based on a location or region associated with the user (e.g., the user is in a blackout area).

Referring to FIG. 3, the unified television application 130 may take the top six movies from the filtered list of suggested movies and include them in the user interface 320 as movies 324a-f. In addition, or in the alternative, the stateless recommendation module 162 may interface with the generative AI module 120 by providing the filtered list of suggested movies to the generative AI module 120 as a prompt for the generative AI module 120. For example, the prompt may be “given that the user likes movie1, movie4, and the movie7, act like an experienced movie recommender and domain expert and recommend movies from the following list of movies (movies 324a-f). Make sure that the suggested movies are similar to the selected movies (movie1, movie4, and the movie7) in terms of story, plot, feel, and genre.” The generative AI module 120 may return a sorted list of movie recommendations that may be included in the recommended movies and TV shows row 334 (e.g., movie 324a and movie 324d).

For example, referring to FIG. 2, the user 101 selected the TV show 206c, the TV show 206e, and the TV show 206h as TV shows the user 101 may be interested in watching. The stateless recommendation module 162 may include the TV show 206c (TV show3), the TV show 206e (TV show5), and the TV show 206h (TV show8) in a list of selected TV shows. The stateless recommendation module 162 may convert the TV show 206c into a respective embedding (e.g., Emb_{TVshow3}). The stateless recommendation module 162 may convert the TV show 206e into a respective embedding (e.g., Emb_{TVshow5}). The stateless recommendation module 162 may convert the TV show 206h into a respective embedding (e.g., Emb_{TVshow8}).

In some implementations, the stateless recommendation module 162 may use a mathematical function such as, for example, an average function to generate a final embedding for the selected TV shows. For example, the stateless recommendation module 162 may use a function as shown in Equation 5 to calculate a final embedding for the user 101.

$${Emb}_{TV show \_ final 1} = Average ( {Emb}_{TVshow 3} , {Emb}_{TVshow 5} , {Emb}_{TVshow 8} ) \qquad Equation 5$$

For example, the stateless recommendation module 162 may use a function as shown in Equation 6 to calculate a final embedding for the user 101. The function shown in Equation 6 may weight each embedding for a TV show by a popularity rating for the TV show.

$${Emb}_{TVshow \_ final 2} = Average ( popularity of TV show 3 * {Emb}_{TVshow 3} , popularity of TV show 5 * {Emb}_{TVshow 5} , popularity of TV show 8 * {Emb}_{TVshow 8} ) \qquad Equation 6$$

The stateless recommendation module 162 interfacing with the unified television application 130 may use a calculated final embedding for a user to search for TV shows similar to the TV shows previously selected by the user for making future suggestions to the user. For example, the unified television application 130 may identify a number of popular TV shows (e.g., 100,000, 10,000, 1000, etc.) for including in a list of popular TV shows. The stateless recommendation module 162 may convert each TV show in the list of popular TV shows into a respective TV show embedding by interfacing with the generative AI module 120. The stateless recommendation module 162 may temporarily include the TV show embeddings in a database in the network-connected display device 104. The stateless recommendation module 162 may perform a dot product with the final embedding for the user and a TV show embedding for each TV show in the list of popular TV shows. For example, the result of the dot product may be a number or score between −1 and +1. A score of +1 between the final embedding for the user and a TV show embedding may indicate that the TV show is similar to TV shows previously selected by the user. A score of −1 between the final embedding for the user and a TV show embedding may indicate that the TV show is not similar to (nearly opposite of) TV shows previously selected by the user.

After calculating a dot product for each TV show included in the list of popular TV shows, the stateless recommendation module 162 may sort the results of the dot products based on the scores, where the TV shows with the higher, larger, or greater scores are included at a top of a list of suggested TV shows because the higher scoring TV shows are more likely to be similar to TV shows previously selected by the user as TV shows of interest to the user. In some implementations, the stateless recommendation module 162 may generate a filtered list of suggested TV shows by removing one or more TV shows from the list of suggested TV shows based on criteria associated with the user. In one non-limiting example, the user may not be able to watch a suggested TV show for free because the user may not have a subscription with the media content provider of the suggested TV show. In another non-limiting example, the TV show may be restricted from playing or watching by the user based on a location or region associated with the user (e.g., the user is in a blackout area).

Referring to FIG. 3, the unified television application 130 may take the top six TV shows from the filtered list of suggested TV shows and include them in the user interface 320 as TV shows 326a-f. In addition, or in the alternative, the stateless recommendation module 162 may interface with the generative AI module 120 by providing the filtered list of suggested TV shows to the generative AI module 120 as a prompt for the generative AI module 120. For example, the prompt may be “given that the user likes TV show3, TV show5, and the TV show8, act like an experienced TV show recommender and domain expert and recommend TV shows from the following list of TV shows (TV shows 326a-f). Make sure that the suggested TV shows are similar to the selected TV shows (TV show3, TV show5, and the TV show8) in terms of story, plot, feel, and genre.” The generative AI module 120 may return a sorted list of TV show recommendations that may be included in the recommended movies and TV shows row 334 (e.g., TV show 326c and TV show 326e).

In some implementations, the recommended movies and TV shows row 334 may list media content items from the additional media content suggestions (movies 322a-f, TV shows 324a-f) that the stateless recommendation module 162 may determine to be of particular interest to the user based on the previous selections of the user of movie 204a, movie 204d, movie 204g, TV show 206c, TV show 206e, and TV show 206h.

In some implementations, referring to FIG. 1B, the recommendation module 124 may generate recommendations for a user based on past user behaviors gathered by the knowledge module 166. The past user behaviors may include, but are not limited to, millions of clicks (e.g., movies and/or TV shows selected or clicked on by a user) and user impressions (e.g., movies and/or TV shows presented to a user in a user interface but not selected or clicked on) across a large user base. This information and data may be stored on the server computer 106 by the recommendation module 124 and used to train a model (e.g., the generative AI model(s) 164). For example, the model once trained may be used to determine how relevant certain features are in determining media content items (e.g., movies and/or TV show) recommendations for a user. The features may include but are not limited to story, plot, feel, and genre. The recommendation module 124 may weigh each feature based on the determined importance, weighing more relevant features more than less relevant features. The recommendation module 124 may implement a stateful recommendation process using the weighted list of recommended media content items (e.g., movies and/or TV show) to generate a list of recommended media content items for viewing by the user. The unified television application 130 may present the recommended media content items in the top picks for you row 119.

Providing a stateless recommendation process to a user allows the user to receive media content suggestions for media content items with features that may be different that those identified as relevant to the user based on the past behavior and watch history of the user. In addition, or in the alternative, because the stateless recommendation process does not store any information and/or data for the media content item selection process, the clicks and user impressions gathered during the stateless recommendation process may not influence any future media content recommendations.

For example, as described above, the stateless recommendation module 162 and/or the unified television application 130 may not store or otherwise save any information and/or data associated with the stateless recommendation process including, but not limited to, embeddings, scores, databases, and lists (e.g., lists of popular TV shows, lists of popular movies, lists of suggested movies, lists of suggested TV shows). Referring to FIG. 1B, whether the user decides to continue with, terminate, end, or select a suggested media content item for viewing, the unified television application 130 and/or the stateless recommendation module 162 may not store or otherwise retain any of the information and data associated with the generating and selecting of the suggested media content items for viewing by a user during the stateless recommendation process. The unified television application 130 and/or the stateless recommendation module 162 may not store or otherwise retain any of the information and data separately or in association with the user. The unified television application 130 may not send or provide any of the information and data associated with the generating and selecting of the suggested media content items for viewing by a user during the stateless recommendation process to the server computer 106 for storing or otherwise retaining by the server computer 106 separately and/or in association with the user. Once the stateless recommendation process has ended, any information and data used to generate suggested media content items for viewing by the user is discarded (not saved or stored).

FIG. 4 illustrates a flowchart 400 depicting example operations of a stateless recommendation process according to implementations described throughout this disclosure. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion. The operations may define a computer-implemented method. Although the flowchart 400 is described with reference to the system 100 of FIG. 1B, the flowchart 400 may be executed according to any of the figures discussed herein. In some examples, the operations of the flowchart 400 are executed by the network-connected display device 104.

Operation 410 includes displaying, by a computing device, media content recommendations in a user interface of a television application based on at least one known preference of a user. For example, referring to FIGS. 1A-B, the network-connected display device 104 may display the user interface 117.

Operation 420 includes receiving, by the computing device, a request for media content suggestions not based on the at least one known preference of the user.

Operation 430 includes, in response to receiving the request for the media content suggestions, initiating, by the television application, a stateless recommendation process. For example, referring to FIGS. 1A-B, the user 101 may click on or select the start new option 113. In response, the unified television application 130 may start or initiate a stateless recommendation process.

Operation 440 includes generating, by the stateless recommendation process, the media content suggestions.

Operation 450 includes displaying the media content suggestions in the user interface of the television application. For example, referring to FIGS. 1A-B, the stateless recommendation process may generate media content selections (e.g., movies 204a-h and TV shows 206a-h) for displaying in the user interface 202.

Operation 460 includes receiving a selection of at least one media content item associated with a respective media content suggestion. For example, referring to FIG. 2, the user may click on or select at least one movie of the movies 204a-h and/or at least one TV show of the TV shows 206a-h.

Operation 470 includes updating, by the stateless recommendation process, the media content suggestions based on the at least one media content item. Referring to FIGS. 1B and 3, the stateless recommendation module 162 may generate an updated list of suggested media content items (e.g., movies 324a-f and TV shows 326a-f) based on the previously selected movies and/or TV shows.

In some examples, the techniques described herein relate to a method including: displaying, by a computing device, media content recommendations in a user interface of a television application based on at least one known preference of a user; receiving, by the computing device, a request for media content suggestions not based on the at least one known preference of the user; in response to receiving the request for the media content suggestions, initiating, by the television application, a stateless recommendation process; generating, by the stateless recommendation process, the media content suggestions; displaying the media content suggestions in the user interface of the television application; receiving a selection of at least one media content item associated with a respective media content suggestion; and updating, by the stateless recommendation process, the media content suggestions based on the at least one media content item.

In some examples, the techniques described herein relate to a method, wherein the media content recommendations are displayed on a home screen of the television application.

In some examples, the techniques described herein relate to a method, wherein updating the media content suggestions based on the at least one media content item includes generating, by the stateless recommendation process, media content suggestions that include media content items semantically similar to the at least one media content item.

In some examples, the techniques described herein relate to a method, wherein the media content suggestions include media content items associated with different genres.

In some examples, the techniques described herein relate to a method, wherein the method further includes identifying at least one genre associated with the at least one media content item; and wherein updating the media content suggestions based on the at least one media content item includes generating, by the stateless recommendation process, media content suggestions that include media content items associated with the at least one genre.

In some examples, the techniques described herein relate to a method, further including: subsequent to displaying the media content suggestions in the user interface of the television application, receiving an indication to end the stateless recommendation process; and terminating, by the television application, the stateless recommendation process, the terminating including not storing any selections received by the stateless recommendation process.

In some examples, the techniques described herein relate to a method, wherein the method further includes: subsequent to terminating the stateless recommendation process, redisplaying the media content recommendations in the user interface of the television application; receiving an indication of a selection of a media content item associated with a respective media content recommendation of the media content recommendations; and playing, by the television application, the media content item on the computing device.

In some examples, the techniques described herein relate to a method, wherein receiving the request for media content suggestions not based on the at least one known preference of the user is based on a mood of the user.

In some examples, the techniques described herein relate to a non-transitory computer-readable medium storing executable instructions that when executed by at least one processor of a computing device cause the at least one processor to execute operations, the operations including: displaying, by the computing device, media content recommendations in a user interface of a television application based on at least one known preference of a user; receiving, by the computing device, a request for media content suggestions not based on the at least one known preference of the user; in response to receiving the request for the media content suggestions, initiating, by the television application, a stateless recommendation process; generating, by the stateless recommendation process, the media content suggestions; displaying the media content suggestions in the user interface of the television application; receiving a selection of at least one media content item associated with a respective media content suggestion; and updating, by the stateless recommendation process, the media content suggestions based on the at least one media content item.

In some examples, the techniques described herein relate to a non-transitory computer-readable medium, wherein the media content recommendations are displayed on a home screen of the television application.

In some examples, the techniques described herein relate to a non-transitory computer-readable medium, wherein updating the media content suggestions based on the at least one media content item includes generating, by the stateless recommendation process, media content suggestions that include media content items semantically similar to the at least one media content item.

In some examples, the techniques described herein relate to a non-transitory computer-readable medium, wherein the media content suggestions include media content items associated with different genres.

In some examples, the techniques described herein relate to a non-transitory computer-readable medium, wherein the operations further include identifying at least one genre associated with the at least one media content item; and wherein updating the media content suggestions based on the at least one media content item includes generating, by the stateless recommendation process, media content suggestions that include media content items associated with the at least one genre.

In some examples, the techniques described herein relate to a non-transitory computer-readable medium, wherein the operations further include: subsequent to displaying the media content suggestions in the user interface of the television application, receiving an indication to end the stateless recommendation process; and terminating, by the television application, the stateless recommendation process, the terminating including not storing any selections received by the stateless recommendation process.

In some examples, the techniques described herein relate to a non-transitory computer-readable medium, wherein the operations further include: subsequent to terminating the stateless recommendation process, redisplaying the media content recommendations in the user interface of the television application; receiving an indication of a selection of a media content item associated with a respective media content recommendation of the media content recommendations; and playing, by the television application, the media content item on the computing device.

In some examples, the techniques described herein relate to a non-transitory computer-readable medium, wherein receiving the request for media content suggestions not based on the at least one known preference of the user is based on a mood of the user.

In some examples, the techniques described herein relate to a system including: at least one processor; and a non-transitory computer-readable medium storing instructions that when executed by the at least one processor cause the system to: display media content recommendations in a user interface of a television application based on at least one known preference of a user; receive a request for media content suggestions not based on the at least one known preference of the user; in response to receiving the request for the media content suggestions, initiate, by the television application, a stateless recommendation process; generate, by the stateless recommendation process, the media content suggestions; display the media content suggestions in the user interface of the television application; receive a selection of at least one media content item associated with a respective media content suggestion; and update, by the stateless recommendation process, the media content suggestions based on the at least one media content item.

In some examples, the techniques described herein relate to a system, wherein the media content recommendations are displayed on a home screen of the television application.

In some examples, the techniques described herein relate to a system, wherein updating the media content suggestions based on the at least one media content item includes generating, by the stateless recommendation process, media content suggestions that include media content items semantically similar to the at least one media content item.

In some examples, the techniques described herein relate to a system, wherein the instructions that when executed by the at least one processor further cause the system to identify at least one genre associated with the at least one media content item; and wherein updating the media content suggestions based on the at least one media content item includes generating, by the stateless recommendation process, media content suggestions that include media content items associated with the at least one genre.

Referring to FIGS. 1A-B, the mobile computing device 102 may be configured to execute the TV application 110. The mobile computing device 102 may include the mobile computing device display 108 configured to display the UI 114. A user may interact with the UI 114 to set up, control, and interact with the TV application 110. In some implementations, as described, the TV application 110 may display the virtual remote control 138 in the UI 114 allowing the user 101 to interact with and control the network-connected display device 104 and/or the media adapter 107.

The mobile computing device 102 may be any type of computing device that includes one or more processors (processor(s) 140), one or more memory devices (memory device(s) 142), and an operating system 144. The mobile computing device 102 may be a smartphone, a tablet, a wearable device, a laptop computer, or a desktop computer. In some implementations, the operating system 144 may be system software that manages computer hardware, software resources, and provides common services for computing programs.

In some implementations, the mobile computing device 102 may be a tablet, a smartphone, or a wearable. In these implementations, the operating system 144 may be referred to as a mobile operating system. The mobile operating system may be configured to execute on devices that, in general, include display devices that may be smaller in size than, for example, a display device included in a laptop computer or a desktop computer. In some implementations, the mobile computing device 102 may be a laptop computer. In these implementations, the operating system may be referred to as a laptop or desktop operating system. In these implementations, the operating system 144 may be an operating system designed for a display that is larger in size than that included in a tablet, a smartphone, or a wearable.

In some implementations, the media adapter 107 (e.g., a casting device, a media streaming device, a media streaming player, a set-top box) may be interfaced with or connected to the network-connected display device 104. The media adapter 107 may interact with and communicate with the media content providers 160, the server computer 106, and the mobile computing device 102 when providing media content to the network-connected display device 104. In some implementations, the media adapter 107 may be embedded in and/or an integrated part of the network-connected display device 104.

The media content providers 160 may include a variety of streaming service and media content sources and service platforms. The media adapter 107 may facilitate providing (e.g., streaming) media content (e.g., streaming video such as movies, TV shows, etc.) from one or more streaming services included in the media content providers 160 to the network-connected display device 104. For example, the media adapter 107 may directly connect to a connector on the network-connected display device 104 by way of connection 165. The media adapter 107 may provide digital video and/or audio to the network-connected display device 104. For example, the media adapter 107 may connect to a high-definition multimedia interface (HDMI) connector included in the network-connected display device 104. Examples of the media adapter 107 may include, but are not limited to, a set-top box, a television box, and a streaming media adapter.

In some implementations, the mobile computing device 102 may connect to or interface with the media adapter 107 by way of a wireless communication link 163a. Wireless communication links 163a-e may be short-range wireless connections such as a Bluetooth connection. In some examples, wireless communication links 163a-e may be a Wi-Fi (e.g., direct Wi-Fi) connection.

The media adapter 107 may be any type of computing device that includes one or more processors (processor(s) 170), one or more memory devices (memory device(s) 172), and an operating system 174. In some implementations, the processor(s) 170 may include a system on a chip (SoC). The SoC may include a central processing unit (CPU), a graphic processing unit (GPU), one or more memory interfaces, and one or more input/output interfaces and devices. In some implementations, the operating system 174 may be system software that manages computer hardware, software resources, and provides common services for computing programs.

The network-connected display device 104 may include the unified television application 130. The unified television application 130 may keep a record of the interactions of the user with the media content received from the server computer 106. The network-connected display device 104 may send the record of the interactions to the server computer 106 for use in determining future media content recommendations for the user.

In some implementations, the network-connected display device 104 may be configured to execute the unified television application 130. For example, the network-connected display device 104 may be a smart television. For example, a smart television may be a network-connected television that may connect to media content providers (e.g., media content providers 160) by way of a network (e.g., the network 150). The media content providers may source media content to the smart television. In these implementations, a user may interact with the unified television application 130 to access media content from the media content providers 160. The unified television application 130 may interface with the server computer 106, and specifically with the server-side TV application 116. The unified television application 130 may provide similar functionality to the user as that provided by an application executing on the media adapter 107. For example, executing the unified television application 130 by the network-connected display device 104 allows the network-connected display device 104 to obtain a media content recommendation stream from the server computer 106.

The network-connected display device 104 may be configured to connect to the network 150. In some implementations, the network-connected display device 104 is a television (e.g., a smart television (TV)). The network-connected display device 104 may include one or more processors (processor(s) 156), one or more memory devices (memory device(s) 152), and an operating system (OS) 154. The operating system 154 may execute (or assist with executing) the unified television application 130.

In some implementations, the operating system 154 may be a browser application. A browser application is a web browser configured to access information on the Internet by way of a network (e.g., the network 150). A browser application may launch one or more browser tabs in the context of one or more browser windows in the browser application. In some implementations, the operating system 154 is a Linux-based operating system configured to execute (or assist with executing) the unified television application 130.

The system 100 may include one or more server computers (e.g., the server computer 106) configured to interface with the mobile computing device 102, the media adapter 107, the media content providers 160, and the network-connected display device 104 by way of the network 150. In some implementations, the network 150 may establish a wireless communication link between the network-connected display device 104, the mobile computing device 102, the media adapter 107, the media content providers 160, and the server computer 106.

The server computer 106 may include the unified media platform (UMP) 158. The UMP 158 may facilitate the providing of media content items to the network-connected display device 104 as described herein.

The server computer 106 may include the server-side TV application 116. The server-side TV application 116 may facilitate providing the media content items for playing on the network-connected display device 104.

The server computer 106 may include a recommendation module 124. The recommendation module 124 may interface with the knowledge module 166 and an artificial intelligence (AI) module 194 to determine recommended media content items for providing or sending to the network-connected display device 104 for use by the unified television application 130 when displaying the top picks for you row 119 in the user interface 117.

The server computer 106 may include the artificial intelligence (AI) module 194. The AI module 194 may receive information and data from the mobile computing device 102 and/or the network-connected display device 104 to build generative artificial intelligence (AI) model(s) 164 for use by the AI module 194.

The AI module 194 may receive updated media content recommendations from the knowledge module 166 along with updated information and data from the mobile computing device 102 and/or the network-connected display device 104 to retrain the generative AI model(s) 164. The AI module 194 may use the retrained generative AI model(s) 164 to update and/or finetune the recommendations for media content items to provide or send to the unified television application 130 for including in the top picks for you row 119 in the user interface 117.

The mobile computing device 102 may include the mobile computing device display 108. In some implementations, the mobile computing device display 108 is a display device such as a liquid crystal display (LCD), a light-emitting diode (LED) display, an organic light-emitting diode (OLED) display, or an active-matrix organic light-emitting diode (AMOLED) display. The network-connected display device 104 may include the display 132. In some implementations, the display 132 is a display device such as a liquid crystal display (LCD), a light-emitting diode display (LED) display, a plasma display, a quantum dot light-emitting diode display (QLED) display, or an organic light-emitting diode (OLED) display.

The processor(s) 156, the processor(s) 140, the processor(s) 170, and the processor(s) 180 may be formed in a substrate configured to execute one or more machine executable instructions or pieces of software, firmware, or a combination thereof. The processor(s) 156, the processor(s) 140, the processor(s) 170, and the processor(s) 180 may be semiconductor-based. For example, the processor(s) 156, the processor(s) 140, the processor(s) 170, and the processor(s) 180 may include semiconductor material that can perform digital logic.

The memory device(s) 152, the memory device(s) 142, the memory device(s) 172, and the memory device(s) 182 may include main memory that stores information in a format that can be read and/or executed by the processor(s) 156, the processor(s) 140, the processor(s) 170, and the processor(s) 180 respectively. The memory device(s) 152, the memory device(s) 142, the memory device(s) 172, and the memory device(s) 182 may include one or more random-access memory (RAM) devices and/or one or more read-only memory (ROM) devices.

The memory device(s) 152, memory device(s) 142, the memory device(s) 172, and the memory device(s) 182 may store applications that, when executed by the processor(s) 156, the processor(s) 140, the processor(s) 170, and the processor(s) 180, respectively, perform operations. For example, the memory device(s) 142 may store the operating system 144 and the TV application 110 that, when executed by the processor(s) 140, may perform operations on the mobile computing device 102. For example, the memory device(s) 152 may store the operating system 154 and the unified television application 130 that, when executed by the processor(s) 156, may perform operations on the network-connected display device 104.

In some implementations, the memory device(s) 182 may represent any kind of (or multiple kinds of) memory (e.g., RAM, flash, cache, disk, tape, etc.). In some implementations, the memory device(s) 182 may include external storage, e.g., memory physically remote from but accessible by the server computer 106. The server computer 106 may include one or more modules, engines, or applications representing specially programmed software. In some implementations, the server computer 106 may include the operating system 184, the server-side TV application 116, the knowledge module 166, the AI module 194, the generative AI model(s) 164, the UMP 158, the recommendation module 124, processor(s) 180, and memory device(s) 182. For example, the memory device(s) 182 may store the operating system 184, the server-side TV application 116, the knowledge module 166, the AI module 194, the generative AI model(s) 164, the UMP 158, and the recommendation module 124 that, when executed by the processor(s) 180, may perform operations on server computer 106 to implement one or more of the methods and processes described herein.

The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within the network 150. The network 150 may further include any number of hardwired and/or wireless connections. The network 150 may be, for example, communications networks having one or more types of topologies, including but not limited to the Internet, intranets, local area networks (LANs), cellular networks, Ethernet, Storage Area Networks (SANs), telephone networks, and Bluetooth personal area networks (PAN). In some implementations, two or more devices in a sub-network may be coupled by way of a wired connection, while at least some of the devices in the same sub-network are coupled by way of a local radio communication network (e.g., ZigBee, Z-Wave, Insteon, Bluetooth, Wi-Fi and other radio communication networks).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

Further to the descriptions above, a user may be provided with controls allowing the user to make an election as to both if and when systems, programs, or features described herein may enable collection of user information (e.g., a user's preferences, a user's current location, a user's credentials, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

1. A method comprising:
in response to launching a television application on a computing device, displaying media content recommendations in a first user interface of the television application based on at least one known preference of a user of the television application;
responsive to a selection of a start new option included in the first user interface of the television application, receiving, by the television application running on the computing device, a request for media content suggestions not based on the at least one known preference of the user;
in response to receiving the request for the media content suggestions, initiating, by the television application, a stateless recommendation process;
generating, by the stateless recommendation process, the media content suggestions;
displaying the media content suggestions in a second user interface of the television application;
receiving a selection of at least one media content item associated with a respective media content suggestion; and
updating, by the stateless recommendation process, the media content suggestions based on the at least one media content item.

2. (canceled)

3. The method of claim 1, wherein the updated media content suggestions include media content items semantically similar to the at least one media content item.

4. The method of claim 1, wherein the media content suggestions include media content items associated with different genres.

5. The method of claim 4,
wherein the method further comprises identifying at least one genre associated with the at least one media content item; and
wherein the updated media content suggestions include media content items associated with the at least one genre.

6. The method of claim 1, further comprising:
subsequent to displaying the media content suggestions in the second user interface of the television application, receiving an indication to end the stateless recommendation process; and
terminating, by the television application, the stateless recommendation process, the terminating comprising not storing any selections received by the stateless recommendation process.

7. The method of claim 6, wherein the method further comprises:
subsequent to terminating the stateless recommendation process, redisplaying the media content recommendations in a third user interface of the television application;
receiving an indication of a selection of a media content item associated with a respective media content recommendation of the media content recommendations; and
playing, by the television application, the media content item on the computing device.

8. The method of claim 1, wherein receiving the request for media content suggestions not based on the at least one known preference of the user is based on a mood of the user.

9. A non-transitory computer-readable medium storing executable instructions that when executed by at least one processor of a computing device cause the at least one processor to execute operations, the operations comprising:
in response to launching a television application on the computing device, displaying media content recommendations in a first user interface of the television application based on at least one known preference of a user of the television application;
responsive to a selection of a start new option included in the first user interface of the television application, receiving, by the television application running on the computing device, a request for media content suggestions not based on the at least one known preference of the user;
in response to receiving the request for the media content suggestions, initiating, by the television application, a stateless recommendation process;
generating, by the stateless recommendation process, the media content suggestions;
displaying the media content suggestions in a second user interface of the television application;
receiving a selection of at least one media content item associated with a respective media content suggestion; and
updating, by the stateless recommendation process, the media content suggestions based on the at least one media content item.

10. (canceled)

11. The non-transitory computer-readable medium of claim 9, wherein the updated media content suggestions include media content items semantically similar to the at least one media content item.

12. The non-transitory computer-readable medium of claim 9, wherein the media content suggestions include media content items associated with different genres.

13. The non-transitory computer-readable medium of claim 12,
wherein the operations further comprise identifying at least one genre associated with the at least one media content item; and
wherein the updated media content suggestions include media content items associated with the at least one genre.

14. The non-transitory computer-readable medium of claim 9, wherein the operations further comprise:
subsequent to displaying the media content suggestions in the second user interface of the television application, receiving an indication to end the stateless recommendation process; and
terminating, by the television application, the stateless recommendation process, the terminating comprising not storing any selections received by the stateless recommendation process.

15. The non-transitory computer-readable medium of claim 14, wherein the operations further comprise:
subsequent to terminating the stateless recommendation process, redisplaying the media content recommendations in a third user interface of the television application;
receiving an indication of a selection of a media content item associated with a respective media content recommendation of the media content recommendations; and
playing, by the television application, the media content item on the computing device.

16. The non-transitory computer-readable medium of claim 9, wherein receiving the request for media content suggestions not based on the at least one known preference of the user is based on a mood of the user.

17. A system comprising:
at least one processor; and
a non-transitory computer-readable medium storing instructions that when executed by the at least one processor cause the system to:
in response to launching a television application on a computing device, display media content recommendations in a first user interface of the television application based on at least one known preference of a user of the television application;
responsive to a selection of a start new option included in the first user interface of the television application, receive, by the television application, a request for media content suggestions not based on the at least one known preference of the user;
in response to receiving the request for the media content suggestions, initiate, by the television application, a stateless recommendation process;
generate, by the stateless recommendation process, the media content suggestions;
display the media content suggestions in a second user interface of the television application;
receive a selection of at least one media content item associated with a respective media content suggestion; and
update, by the stateless recommendation process, the media content suggestions based on the at least one media content item.

18. (canceled)

19. The system of claim 17, wherein the updated media content suggestions include media content items semantically similar to the at least one media content item.

20. The system of claim 17,
wherein the instructions that when executed by the at least one processor further cause the system to identify at least one genre associated with the at least one media content item; and
wherein the updated media content suggestions include media content items associated with the at least one genre.

21. The system of claim 17, wherein the instructions that when executed by the at least one processor further cause the system to:
subsequent to displaying the media content suggestions in the second user interface of the television application, receive an indication to end the stateless recommendation process; and
terminate the stateless recommendation process, the terminating comprising not storing any selections received by the stateless recommendation process.

22. The method of claim 1,
wherein the second user interface includes a continue button; and
wherein updating, by the stateless recommendation process, the media content suggestions based on the at least one media content item is responsive to receiving a selection of the continue button.

23. The method of claim 22, wherein the method further comprises displaying the updated media content suggestions in a third user interface of the television application, the third user interface including a row of recommended media content items of the updated media content suggestions.
